(19) United States
(12) Patent Application Publication
(10) Pub. No.: US 2021/0262556 A1
(43) Pub. Date: Aug. 26, 2021

(54) POWERTRAIN WITH A CONTINUOUSLY VARIABLE TRANSMISSION FOR AN ELECTRIC VEHICLE AND METHOD FOR OPERATING SUCH POWERTRAIN

(71) Applicant: Robert Bosch GmbH, Stutthart (DE)

(72) Inventors: Lucas Hubertus Johannes Römers, Berg aan de Maas (NL); Manuel Gärtner, Burgstetten (DE)

(21) Appl. No.: 17/277,028

(22) PCT Filed: Sep. 18, 2019
(86) PCT No.: PCT/EP2019/025309

§ 371 Date: Mar. 17, 2021

(30) Foreign Application Priority Data
Sep. 18, 2018 (EP) PCT/EP2018/025237

(51) Int. Cl. F16H 37/02

(52) U.S. Cl. CPC F16H 37/021; F16H 2200/0026; F16H 2200/0021

(57) ABSTRACT

The invention relates to a powertrain for a fully electric vehicle comprising an electric machine (1), a driven wheel (2) and a gearing (3) that is arranged between the electric machine (1) and the driven wheel (2) and that provides a driving connection there between, which gearing (3) includes at least a first speed reduction stage (31) providing a fixed first speed ratio, a variator unit (40) providing a variable speed ratio and a second speed reduction stage (32) providing a fixed second speed ratio between an input gear wheel (35) and an output gear wheel (36) thereof, whereof the input gear wheel (35) rotates as one with the output shaft of variator unit (40). According to the invention, a maximum overall speed ratio provided by the gearing (3) between the electric machine (1) and the driven wheel (2) amounts to at least 20:1.

### BACKGROUND

The present invention relates to a powertrain for or in an electric vehicle, in particular a passenger car, with an electric machine (EM), also known as a motor/generator device, a driven wheel or wheels and with a gearing that drivingly connects, i.e. rotationally couples, the EM to the driven wheels. Typically, the said gearing provides a fixed speed (reduction) ratio between the EM and the driven wheels. Such speed ratio provided by the gearing determines, on the one hand, a maximum attainable vehicle speed and, on the other hand, a maximum attainable torque level at the driven wheels at standstill, which torque level determines the launch performance (including the so-called gradeability) of the electric vehicle.

It is noted that within the context of the present disclosure the term electric vehicle is to be understood as referring to a purely electric vehicle, i.e. as excluding a so-called hybrid motor vehicle. In other words, the presently considered powertrain includes only the electric machine as a prime mover and does, in particular, not include an internal combustion engine that is, or at least can be, connected to the driven wheels in addition to or instead of the electric machine.

Because the EM typically has a much wider range of attainable rotational speeds than the known internal combustion engine (ICE), such a fixed ratio gearing can provide the electric vehicle powertrain with a reasonable dynamic performance. Nevertheless, the maximum vehicle speed is limited by a maximum rotational speed of the EM. To overcome such limitation it has been proposed in the art to include a 2-speed transmission in the gearing, such that a low or a high gear can be selected between the EM and the driven wheels. By such 2-speed transmission the maximum attainable vehicle speed increases (in high gear) without compromising the vehicle launch performance (in low gear). Additionally, the 2-speed transmission allows for an improvement of the operating efficiency of the electric vehicle powertrain, since the EM can thereby be operated at one of two speed values in relation to the vehicle speed, in particular at the one value that provides the powertrain with the higher efficiency.

### SUMMARY

Multiple (i.e. 3- or more) speed transmissions, including continuously variable transmissions (CVTs), are currently not applied in the known electric vehicle powertrain, at least not commercially, because already with the 2-speed transmission ample torque can be generated at the drive wheels at standstill while still enabling a customary maximum vehicle speed, even in comparison with a conventional ICE powertrain. However, according to the present invention and in contrast with the aforementioned, prevailing insights and state of the art design considerations, the CVT, or at least the key parts thereof known as a variator unit (i.e. those parts that are minimally required to vary the speed ratio between an input shaft and an output shaft thereof), can provide the electric vehicle powertrain with an unexpected technical advantage. In particular according to the present invention, by including the variator unit in the gearing of the electric vehicle powertrain, the EM can be downsized considerably. Hereto, the present invention relies on a lesser known characteristic of the EM, namely that its maximum, i.e. peak torque level to a large extend determines its physical size, weight and unit cost, whereas a peak power level of that EM is typically only a secondary factor. Therefore, by including the variator unit in the electric vehicle powertrain, the EM can be downsized in terms of, at least, its peak torque level, favourably without substantially compromising the EM peak power, i.e. favourably substantially without compromising the power specification and launch performance of the electric vehicle. Moreover, also a continuous power of the EM, as well as the maximum vehicle speed that is largely determined by such EM continuous power, can remain largely unaffected by such downsizing, at least within a reasonable downsizing ratio.

For example, according to the present invention, the peak torque required from EM during operation of the electric vehicle can be favourably reduced to between one and two thirds, typically, by including the variator unit in the electric vehicle powertrain. Additionally, a maximum rotational speed required from the EM during operation can typically be favourably reduced thereby by 15% to 35%. In particular according to the present invention, the thus downsized EM is preferably characterised by an at least essentially constant EM peak torque as a function of its rotational speed, at least in predominant part of its speed range, i.e. for more than 50%. Preferably, however, the EM peak torque is constant for at least 80%, more preferably for at least 90% or even 95% of the EM speed range. As a result the EM peak power of the electric vehicle is hardly compromised. Preferably, the EM is designed to generate its peak torque in its entire speed range, i.e. up to its maximum operating speed.

Preferably, the gearing further includes two speed reduction stages, each providing a fixed speed reduction ratio between an upstream or input gear wheel and a downstream or output gear wheel thereof, whereof a first stage is incorporated between the EM and the variator unit and whereof a second stage is incorporated between the variator unit and the driven wheels, which second stage normally includes at least a differential gearing for distributing a driving power between two or more driven wheels of the electric vehicle. The maximum overall speed reduction provided by the gearing, i.e. by the said two speed reduction stages and the variator unit, preferably amounts to at least 20, more preferably to 30 or more. This maximum overall speed reduction is much higher than what is typically applied in the state of the art electric vehicle powertrain without the variator unit, which feature is enabled by the variator unit and allows for the above-discussed EM downsizing.

Preferably, a ratio coverage of the variator unit, as defined by the quotient between a largest and a smallest speed ratio between an input shaft and an output shaft thereof, amounts to between 3.5 and 4.5, preferably about 4, such that by shifting the variator unit the overall speed reduction of the gearing can be continuously reduced to about one quarter of the said maximum value thereof. In comparison with the ratio coverage of the state of the art CVT for the conventional ICE powertrain, a ratio coverage of about 4 is surprisingly small, but at the same time it is found to be entirely adequate for the presently considered electric vehicle powertrain.

It is a well-known feature of most variator unit designs, including in particular a drive belt-and-pulleys-type variator unit, that these provide the said speed ratio range symmetrically around unity, i.e. around 1 to 1 speed ratio. For example, in case of the above-mentioned variator ratio coverage of 4, a largest speed ratio of the variator unit amounts to 2:1 and a smallest one amounts to 1:2. However, according to the present invention, in the electric vehicle powertrain, the variator unit preferably provides an asymmetric speed ratio range instead, with the said largest variator speed ratio thereof being considerably larger than the inverse value of the said smallest variator speed ratio thereof. In particular according to the present invention, the largest variator speed ratio amounts to at least 125%, preferably at least 140% of the inverse value of its smallest speed ratio. In a specific embodiment of the variator unit according to the present invention, its largest speed ratio amounts to 2.4:1 and its smallest speed ratio amounts to 1:1.67, such that the ratio coverage of that variator unit amounts to (2.4:1)/(1:1.67)=4.0.

By the above-described feature of the asymmetric variator speed ratio range, the operating efficiency of the electric vehicle powertrain could be improved for a given variator ratio coverage. In particular, by reducing a rotational speed of the output shaft of the variator unit during operation by increasing the said smallest speed ratio thereof (for a given variator ratio coverage), the internal power loss of the variator unit—that is a/o proportional to such output speed—is favourably reduced as well. In this respect, it is noted that this latter design feature and efficiency optimisation of the variator unit are unique to the presently considered electric vehicle powertrain. To the contrary, the operating efficiency of the conventional ICE powertrain is known to benefit most from a largest possible and, hence, symmetric variator speed ratio range.

A further optimisation possibility for the operating efficiency of the electric powertrain according to the present invention lies in the selection of the speed reduction ratios provided by the said two speed reduction stages individually. According to the present invention, the speed reduction ratio of the first (“upstream”) stage is preferably set as large as possible, in particular as determined by the mathematical quotient of a (maximum) torque transmitting capability of the variator unit and the EM peak torque. Such preferred, large speed reduction ratio of the first speed reduction stage—that can even exceed that of second speed reduction stage—further supports the presently considered EM downsizing. In this respect, it is observed that the state of the art electric vehicle powertrain typically also includes two speed reduction stages, however, with the speed reduction ratio provided by the second (“downstream”) stage being considerably larger than that of the first (“upstream”) stage. Such state of the art design is linked to the circumstance that the second speed reduction stage includes or is realised by a pinion wheel and a crown wheel of the differential gearing that provide a relatively large speed reduction ratio by design.

A first favourable side effect of the asymmetric variator speed ratio range, in particular in case of the said belt-and-pulleys-type variator unit, is that its output shaft can be provided with a larger diameter than its input shaft, which is ideally suited to cope with the large torque amplification of the largest variator speed ratio in the said asymmetric range. In case of the said belt-and-pulleys-type variator unit a second favourable side effect of the asymmetric variator speed ratio range occurs. Namely of this type of variator unit, its input pulley can be provided with a smaller outer diameter than its output pulley, which is ideally suited for a physical arrangement of the powertrain that requires only a limited building space, especially in the height direction of the electric vehicle. In particular, the variator unit is oriented upwards in the downstream direction, i.e. in the direction from its input shaft to its output shaft. As a result, the powertrain as a whole can be located favourably low in the vehicle, i.e. close(st) to a road surface.

### BRIEF DESCRIPTION OF THE DRAWINGS

The invention will be explained in more detail by means of non-limiting, illustrative embodiments thereof and with reference to the drawing, in which:

FIG. 1 is a schematic representation of the functional arrangement of the main components of a known electric vehicle powertrain;

FIG. 2 is a schematic representation of the functional arrangement of the main components of a novel electric vehicle powertrain in accordance with the present invention; and

FIG. 3 is a graph illustrating the peak torque vs rotational speed characteristic of two differently specified electric machines.

### DETAILED DESCRIPTION

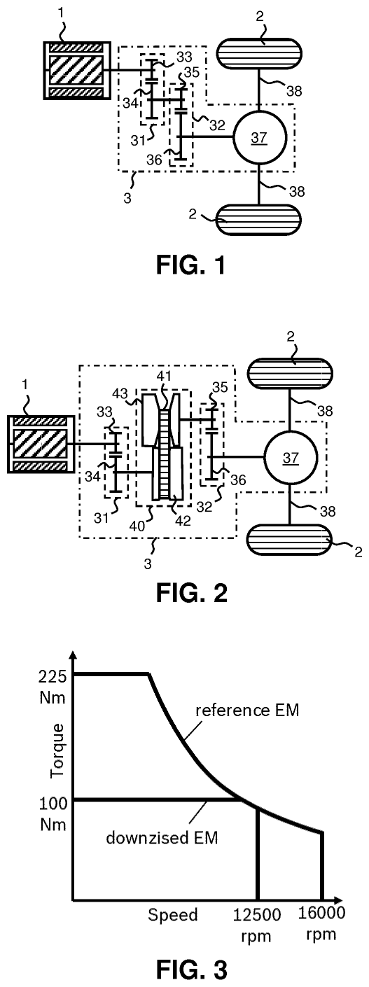

FIG. 1 shows a basic example of a known powertrain for an electric vehicle such as a passenger car. The known electric vehicle powertrain comprises an electric machine 1 (EM), also known as a motor/generator device, two driven wheels 2 of the electric vehicle and a gearing 3 that drivingly connects the EM 1 to the driven wheels 2. In the embodiment of FIG. 1 the known gearing 3 provides a fixed speed ratio between the EM 1 and the driven wheels 2 by means of a gear train consisting of two speed reduction stages 31, 32 of two meshing gear wheels 33, 34; 35, 36 each that are arranged in series. An upstream gear wheel 33 of a first, i.e. upstream speed reduction stage 31 is directly driven by, i.e. rotates as one with the EM 1, preferably by being placed on a rotor shaft thereof. A downstream gear wheel 34 of the first speed reduction stage 31 rotates as one with an upstream gear wheel 35 of a second, i.e. downstream speed reduction stage 32, typically by being placed on a common shaft. A downstream gear wheel 36 of the second speed reduction stage 32 drives the driven wheels 2 through a differential gearing 37 for distributing a driving power between two or more driven wheels 2 of the electric vehicle through a drive shaft 38. Actually, the second speed reduction stage 32 can be embodied by a pinion wheel and a crown wheel of the differential gearing 37, i.e. as an integral part of the differential gearing 37.

The overall speed reduction ratio provided by the gearing 3 determines, on the one hand, a maximum attainable speed of the electric vehicle and, on the other hand, a maximum attainable torque level at the driven wheels 2 of the electric vehicle at standstill. In this respect it may be observed that, at least in theory, only a single speed reduction stage could be applied in the known electric vehicle powertrain. However, because of the relatively high maximum rotational speed of the EM 1, the speed reduction ratio that is required between the EM 1 and the driven wheels 2 would require an impractically sized gear wheels. In particular, a speed reduction ratio of more than 10:1, typically of around 12:1 is required from the gearing 3 overall.

As an improvement of the known electric vehicle powertrain of FIG. 1 and in accordance with the present invention, a variator unit 40, providing a continuously variable speed ratio between an input shaft and an output shaft thereof, is included therein, for example in the manner illustrated in FIG. 2. The variator unit 40 is as such well-known, in particular in the form comprising a drive belt 41 that is wrapped around and in frictional contact with both an input pulley 42 on the input shaft and an output pulley 43 on the output shaft of the variator unit 40. An effective radius of the friction contact between the drive belt 41 and a pulley 42, 43 can be varied in mutually opposite directions between the two pulleys 42, 43 by means of a control and actuation system of the variator unit 40 (not shown), such that a speed ratio provided by the variator unit between its input pulley 42 and its output pulley 43 can be continuously varied with a certain range. For example, in a largest speed ratio within such variator speed ratio range, a rotational speed of its output pulley 43 is maximally reduced relative to a rotational speed of its input pulley 42 by the drive belt 41 contacting the input pulley 42 at a small effective radius and the output pulley 43 at a large effective radius.

Evidently this latter, novel arrangement of the electric vehicle powertrain and of its gearing 3 in particular is more complex than the known arrangements without variator unit 40. However, according to the present invention, the novel arrangement favourably allows for a downsizing of the EM 1, such that the overall cost of manufacturing and/or the overall operating efficiency of the novel powertrain can in fact be improved.

In the graph of FIG. 3, a specific example is provided of the EM downsizing that is attainable with the novel powertrain. In particular, in the specific example of FIG. 3, a peak torque level of the EM 1 is reduced from 225 Nm in the known powertrain to 100 Nm in the novel powertrain. Moreover, the peak torque level of the downsized EM 1 is largely unrelated to its rotational speed. Additionally, in the specific example of FIG. 3, a maximum operating speed of the EM 1 is reduced from 16,000 rpm in the known powertrain to 12,500 rpm in the novel powertrain. To the contrary, the peak power of the downsized EM 1 in the novel powertrain has remained the same as that of the known powertrain at 120 kW.

To enable the EM downsizing illustrated in FIG. 3, the gearing 3 is specified as follows:
the largest speed ratio of the variator unit 40 is 2.4;
the ratio coverage of the variator unit 40 is 4;
the speed reduction ratio of the first speed reduction stage 31 equals 3.6; and
the speed reduction ratio of the second speed reduction stage 32 equal 3.5.

The present invention, in addition to the entirety of the preceding description and all details of the accompanying figures, also concerns and includes all of the features in the appended set of claims. Bracketed references in the claims do not limit the scope thereof, but are merely provided as a non-limiting example of a respective feature. Separately claimed features can be applied separately in a given product, or in a given process as the case may be, but these can also be applied simultaneously therein in any combination of two or more of such features.

The invention is not limited to the embodiments and/or the examples that are explicitly mentioned herein, but also encompass(es) straightforward amendments, modifications and practical applications thereof, in particular those that lie within reach of the person skilled in the relevant art.

Please amend the listing of claims as follows:

1. A method for operating a powertrain for or in a fully electric vehicle, which powertrain comprises an electric machine (1), a driven wheel (2) and a gearing (3) that is arranged between the electric machine (1) and the driven wheel (2) and that provides a driving connection there between, which gearing (3) includes a first speed reduction stage (31) providing a fixed first speed ratio between an input gear wheel (33) and an output gear wheel (34) thereof, whereof the input gear wheel (33) rotates as one with the electric machine (1), which gearing (3) further includes a variator unit (40) providing a variable speed ratio between an input shaft and an output shaft thereof, whereof the input shaft rotates as one with the output gear wheel (34) of the first speed reduction stage (31), and which gearing (3) yet further includes a second speed reduction stage (32) providing a fixed second speed ratio between an input gear wheel (35) and an output gear wheel (36) thereof, whereof the input gear wheel (35) rotates as one with the output shaft of variator unit (40), in which method, during operation of the powertrain, the electric motor (1) is controlled to generate a torque level between zero and a peak torque in dependence on one or more operating parameters of the electric vehicle, characterized in that the peak torque is independent of a controlled rotational speed of the electric motor (1) in a range between zero and at least 50% of a maximum controlled rotational speed of the electric motor (1).

2. The method for operating a powertrain for or in a fully electric vehicle according to claim 1, characterized in that the peak torque is independent of a controlled rotational speed of the electric motor (1) in a range between zero and at least 80% of a maximum controlled rotational speed of the electric motor (1).

3. The method for operating a powertrain for or in a fully electric vehicle according to claim 1, characterized in that the peak torque is, or at least can be, generated in an entirety of an operational speed range of the electric motor (1).

4. A powertrain for or in a fully electric vehicle, which powertrain comprises an electric machine (1), a driven wheel (2) and a gearing (3) that is arranged between the electric machine (1) and the driven wheel (2) and that provides a driving connection there between, which gearing (3) includes at least a first speed reduction stage (31) providing a fixed first speed ratio between an input gear wheel (33) and an output gear wheel (34) thereof, whereof the input gear wheel (33) rotates as one with the electric machine (1), which gearing (3) further includes a variator unit (40) providing a variable speed ratio between an input shaft and an output shaft thereof, whereof the input shaft rotates as one with the output gear wheel (34) of the first speed reduction stage (31), and which gearing (3) yet further includes a second speed reduction stage (32) providing a fixed second speed ratio between an input gear wheel (35) and an output gear wheel (36) thereof, whereof the input gear wheel (35) rotates as one with the output shaft of variator unit (40), characterized in that a maximum overall speed ratio provided by the gearing (3) between the electric machine (1) and the driven wheel (2) is at least 20:1.

5. The powertrain according to claim 4, characterized in that the fixed first speed ratio provided by the first speed reduction stage (31) is in the range from 3:1 to 4:1.

6. The powertrain according to claim 4, characterized in that the fixed first speed ratio provided by the first speed reduction stage (31) is larger than the fixed second speed ratio provided by the second speed reduction stage (32).

7. The powertrain according to claim 4, characterized in that a ratio coverage of the variator unit (40), as defined by the mathematical quotient between a largest speed ratio and a smallest speed ratio thereof, is between 3.5 and 4.5.

8. The powertrain according to claim 7, characterized in that the largest speed ratio of the variator unit (40) is larger than an inverse value of the smallest speed ratio thereof.

9. The powertrain according to claim 8, characterized in that a diameter of the output shaft of the variator unit (40) is larger than a diameter of an input shaft of the variator unit (40).

10. The powertrain according to claim 8, characterized in that the variator unit (40) comprises an input pulley (42) on its input shaft, an output pulley (43) on its output shaft and a drive belt (41) that is wrapped around and in frictional contact with the input and output pulleys (42, 43) and in that an outer diameter of the input pulley (42) is smaller than an outer diameter of the output pulley (43).

11. (canceled)

12. The method for operating a powertrain for or in a fully electric vehicle according to claim 2, characterized in that the peak torque is independent of a controlled rotational speed of the electric motor (1) in a range between zero and at least 90% of a maximum controlled rotational speed of the electric motor (1).

13. The method for operating a powertrain for or in a fully electric vehicle according to claim 2, characterized in that the peak torque is independent of a controlled rotational speed of the electric motor (1) in a range between zero and at least 95% of a maximum controlled rotational speed of the electric motor (1).

14. The powertrain according to claim 4, characterized in that the maximum overall speed ratio provided by the gearing (3) between the electric machine (1) and the driven wheel (2) is at least 30:1.

15. The powertrain according to claim 4, characterized in that the fixed first speed ratio provided by the first speed reduction stage (31) is 3.6:1.

16. The powertrain according to claim 6, characterized in that the fixed second speed ratio provided by the second speed reduction stage (32) is 3.5:1.

17. The powertrain according to claim 7, characterized in that the ratio coverage of the variator unit (40), as defined by the mathematical quotient between a largest speed ratio and a smallest speed ratio thereof, is about 4.

18. The powertrain according to claim 8, characterized in that the largest speed ratio of the variator unit (40) is equal to 2.4:1 with the smallest speed ratio being equal to 1:1.67.
